(19) United States
(12) Patent Application Publication
(10) Pub. No.: US 2012/0304869 A1
(43) Pub. Date: Dec. 6, 2012

(54) Hot Beverage Maker and Dispenser

(76) Inventors: Taylor Kwok, Hong Kong (CN); Kenneth D. Corby, Rochester, NY (US); Anthony Ilacqua, Rochester, NY (US); John Erickson, Victor, NY (US)

(21) Appl. No.: 13/579,337

(22) PCT Filed: Dec. 10, 2010
(86) PCT No.: PCT/US2010/059801

§ 371 Date: Aug. 16, 2012

Related U.S. Application Data
(60) Provisional application No. 61/307,483, filed on Feb. 24, 2010.

(51) Int. Cl. A47J 31/46

(52) U.S. Cl. 99/299

(57) ABSTRACT

A hot beverage maker and dispensing system (10) is provided having an integral beverage reservoir (110) that uses positive air pressure to dispense the brewed beverage from the reservoir (110). The positive air pressure is generated by an electric pump (150) that is energized when an actuator (210) is depressed by a container to be filled with the brewed beverage. The actuator (210) also causes a first valve (42) to pause the beverage during brewing into a brew head (300) from being directed into the reservoir (110). The actuator (210) also causes a second valve (241) in the lid (115) of the reservoir (110) to seal the reservoir (110). Thus, positive air pressure generated by the electric pump (150) forces the beverage in the reservoir (110) through a dispensing outlet (215) into the container. When the actuator (210) is release!, the brewing of the beverage may resume and the beverage may again be directed from the brew head (300) into the reservoir (110).

### FIELD OF THE INVENTION

The invention relates generally to hot beverage makers, and more particularly, to a coffee brewer that uses an integral coffee reservoir that uses positive air pressure to dispense the brewed coffee from the reservoir.

### BACKGROUND OF THE INVENTION

There exists in the art automatic drip coffee makers that brew coffee using a system that generates hot water that is dispersed over ground coffee contained in an integral brew basket with coffee filter. The brewed coffee then flows into a removable glass or thermal carafe. The glass carafe sits on a warmer plate to keep the brewed coffee at a desired temperature. A thermal (vacuum or foam insulated) carafe does not use a warmer plate and relies on the insulating qualities of the carafe to keep the coffee hot for an appropriate period of time. In either case, for dispensing coffee into individual cups or mugs, the carafe is removed from the coffee maker by the end user and held in-hand for pouring and then returned to the position on the coffeemaker base.

One problem with prior art coffee brewers is that a 12 cup carafe can weigh close to five pounds and the offset of the carafe handle puts the weight further out from the hand. This may be uncomfortable or unacceptable physical stress for the elderly or for those with physical limitations such as arthritis. This may make the process of handling the carafe and pouring into individual cups or mugs difficult or impossible for some people.

### SUMMARY OF THE INVENTION

In an embodiment, there is provided a beverage maker and dispensing system (10), comprising a base (15), a brewed beverage tank (110) removably mounted on the base (15) having an inlet (115a) and an outlet (215), a brew head (300) for brewing a brewed beverage which is directed into the brewed beverage tank (110) through the inlet (115a), an actuator (210) configured to dispense a brewed beverage from the outlet (215) when the actuator (210) is depressed, and an electric pump (150) configured to pressurize the beverage tank (110) when the actuator (210) is depressed causing the brewed beverage to be dispensed.

In an embodiment, there is provided a beverage maker and dispensing system (10), comprising a base (15), a pressurized brewed beverage tank (110) removably mounted on the base (15) having an inlet (115a) and an outlet (215), a brew head (300) configured to brew a brewed beverage which is directed into the brewed beverage tank (110) through the inlet (115a), and an actuator (210) configured to dispense a brewed beverage from the outlet (215) when the actuator (210) is depressed by a container.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front right perspective view of an embodiment of a hot beverage maker and dispenser;

FIG. 2 is another front right perspective view of the hot beverage maker and dispenser of FIG. 1 with a brew tank assembly removed from a base;

FIG. 3A is a top view of the hot beverage maker and dispenser of FIG. 2;

FIG. 3B is a top view of the brew tank assembly of FIG. 2 removed from the base;

FIG. 4 is an exploded rear perspective view of the brew tank assembly of FIGS. 2 and 3B;

FIG. 5 is a top rear perspective view of a lid assembly and a portion of a slide assembly mounted on the lid assembly;

FIG. 6 is a bottom perspective view of the lid assembly of FIG. 5;

FIG. 7 is an exploded right perspective view of the base of the hot beverage maker and dispenser of FIG. 1;

FIG. 8 is a sectional view taken along line 3B-3B of FIG. 3A of the lid assembly shown in FIGS. 5 and 6 and a brew basket assembly with an actuator in a normal position; and

FIG. 9 is another sectional view taken along line 3B-3B of FIG. 3A of the lid assembly shown in FIGS. 5 and 6 and the brew basket assembly with the actuator in a depressed position.

### DETAILED DESCRIPTION OF THE INVENTION

A hot beverage maker is provided having an integral beverage reservoir that uses positive air pressure to dispense the brewed beverage from the reservoir when an actuator is depressed.

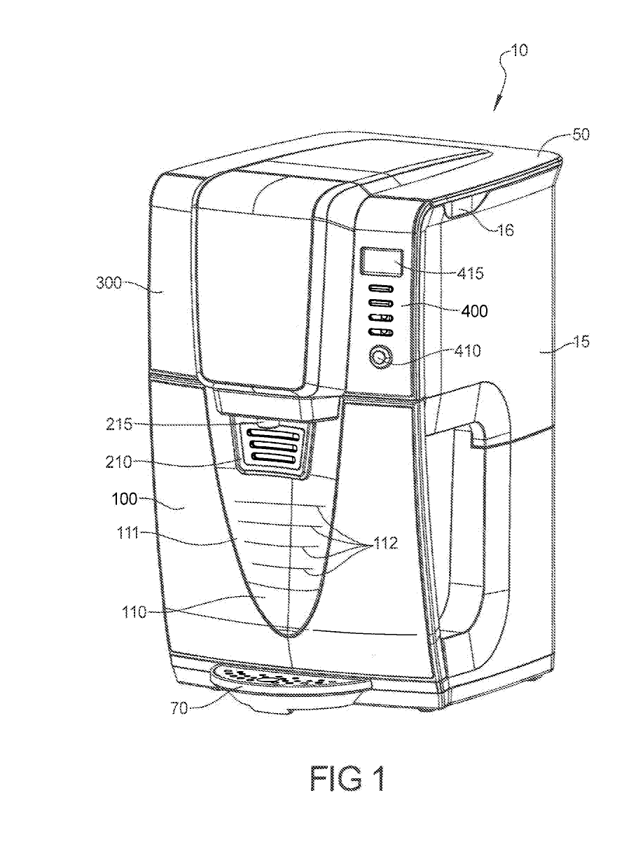

Referring now to the drawing figures in which like reference designators refer to like elements, there is shown in FIG. 1 an embodiment of a hot beverage maker and dispenser 10. In the illustrated embodiment, the hot beverage maker and dispenser 10 is a coffee brewer and dispenser, hereinafter referred to as coffee brewer 10. However, this is not meant to be limiting as the hot beverage maker and dispenser 10 may be any type of hot beverage maker where water is passed through a material to be infused (such as coffee grounds) and stored in a reservoir for further dispensing as is known to one of ordinary skill in the art.

The coffee brewer 10 is comprised of a base 15, a brew tank assembly 100 that removably mounts in the base 15, an actuator 210, a brew head 300, and electronic controls 400. The brew tank assembly 100 includes a brew tank 110 having a translucent recessed portion 111 disposed behind the actuator 210. The recessed portion 111 is sized and shaped to allow a cup, mug or other receptacle to be placed against the actuator 210, allowing the actuator 210 to be depressed into the recessed portion 111 thereby causing a hot beverage to be dispensed into the receptacle. The liquid level in the brew tank 110 may be viewed through the translucent recessed portion 111. The brew tank 110 may include liquid level markings 112 on the translucent recessed portion 111 for determining the liquid level in the brew tank 110. A u-shaped recess on opposing sides of the base 10 also allow the liquid level to be viewed in the brew tank 110 and allow the brew tank assembly 100 to be more easily grasped for removal from the base 15. A brewed beverage in the brew tank 100 flows under pressure through an outlet 215 into the receptacle when the receptacle engages the actuator 210. The operation of the actuator 210 and the dispensing of the brewed beverage from the brew tank 110 is described more fully hereinbelow.

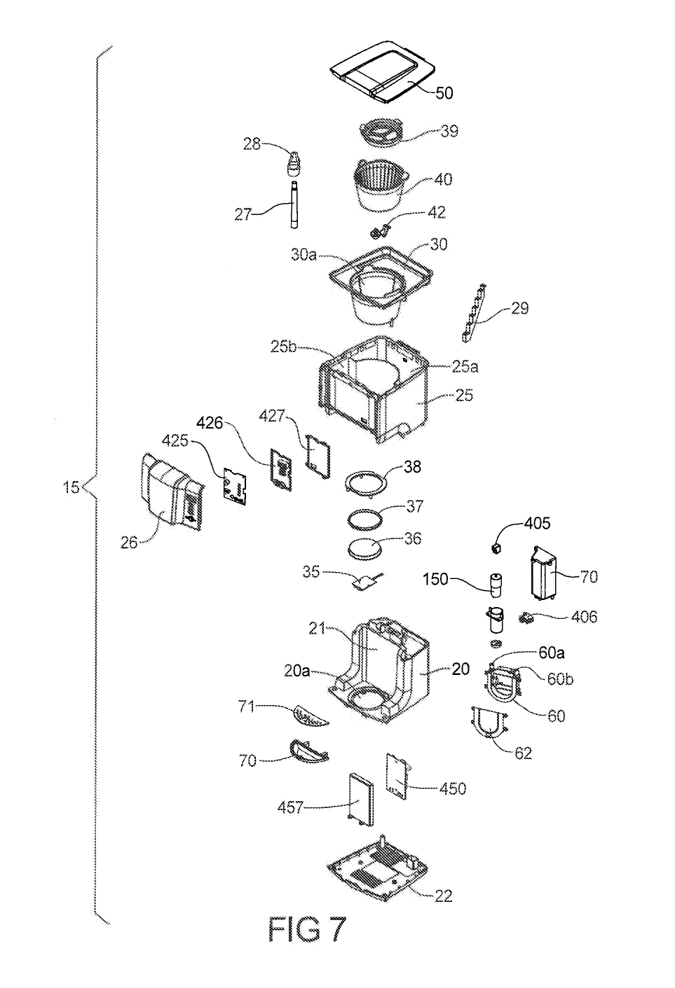

In an embodiment, the electronic controls 400 may include a power button 410 to start/stop the brewing cycle and control power to heating elements 35 and 60 (FIG. 7) disposed in the base 15 beneath and behind the brew tank 110. The heating element 60 (FIG. 7) heats and delivers the water to the sprayer 28 for brewing the hot beverage that is finally dripped into the brew tank 110. The heating element 35 (FIG. 7) keeps the contents of the brew tank 110 heated after the hot beverage has been brewed and dripped into the brew tank 110. The operation of the heating elements 35 and 60 are described more fully hereinbelow.

In another embodiment, the electronic controls 400 may be connected to a microprocessor (not shown) to control the operation of the brewing cycle, the heating element 35 (FIG. 7), and dispensing of the brewed beverage. An Electronic Display 415 may be used to provide information to a user. For example, the Electronic Display 415 may be used to indicate current time, brew cycle start/stop time, brewing cycle status, delay brew time, whether heating elements 35 and 60 (FIG. 7) are hot, or the like. The operation of the electronic controls 400 in the coffee brewer 10 are known in the art and require no further discussion.

It should be understood that neither of the foregoing embodiments of electronic controls and features are meant to limiting as there may be many other possible embodiments of electronic controls and features known to one of ordinary skill in the art.

In an embodiment, the coffee brewer 10 may include an outwardly extending drip tray 70 disposed at the bottom of the base 15 for catching drips from outlet 215. The drip tray 70 may include a drip tray cover 71 including a plurality of holes. The drip tray 70 may be removably mounted for emptying and cleaning. The drip tray 70 may include a plurality of parallel fins (not shown) extending upwardly from the bottom of the internal cavity for reducing splashing of collected beverage.

In an embodiment, a hinged lid 50 on the top of base 15 opens for allowing a water tank 25 (FIG. 7) to be filled with water. A detent 16 on the top and one or more sides of base 15 aids in opening of the lid 50 for filling the tank 25 (FIG. 7). In use, the lid is generally kept in a closed position.

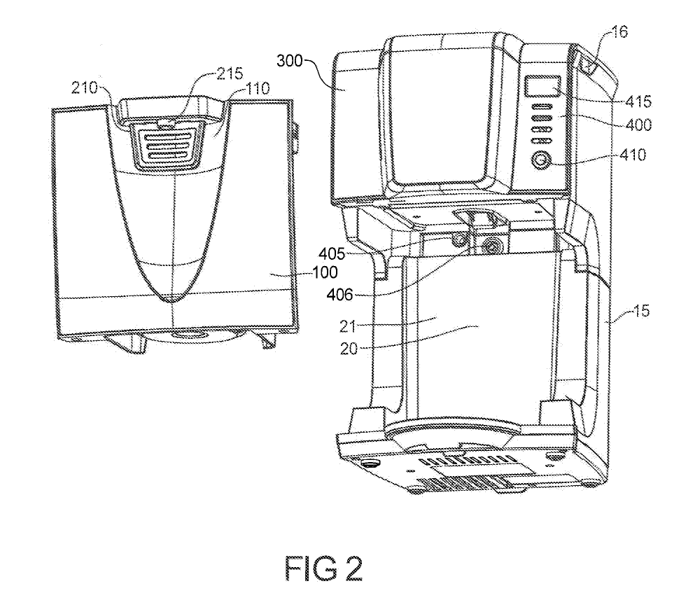

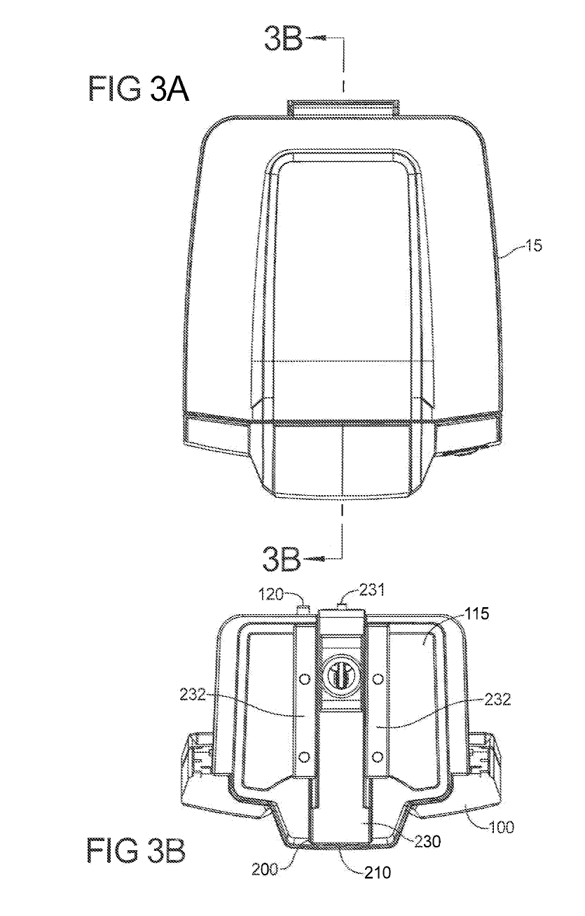

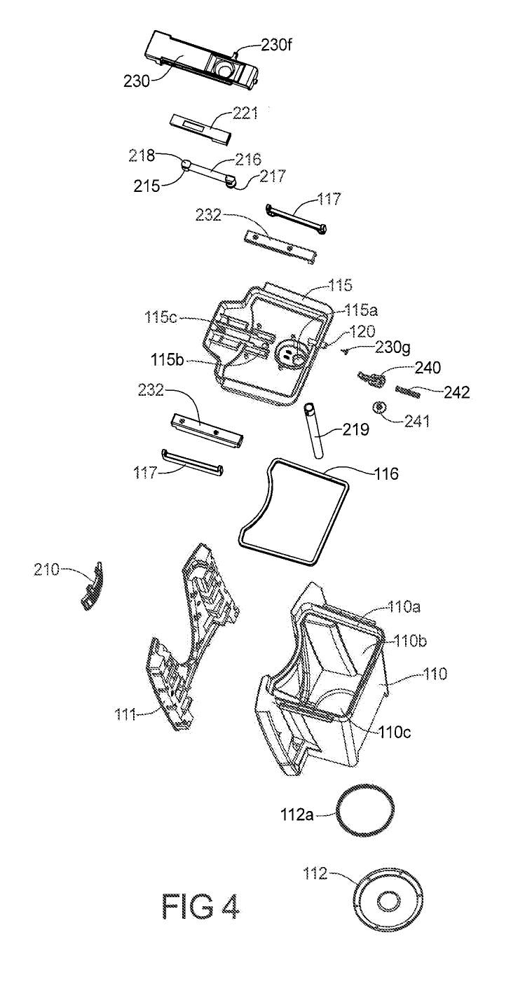

Referring now to FIGS. 2 and 3, illustrated is the brew tank assembly 100 removed from a brew tank recess 20 in the base 15. In operation, the brew tank assembly 100 is inserted into the brew tank recess 20 beneath brew head 300. The brew tank assembly 100 may be removed from the base 15 after completion of the brewing cycle for disposing of unused beverage which may be poured into a drain or otherwise for disposal. The brew tank assembly 100 includes a removable cover 115 (best seen in FIG. 4) for emptying the unused contents when desired. The actuator 210 is connected to an actuator assembly 200 which is slidingly mounted on an upper surface of the cover 115. The outlet 215 is positioned above the actuator 210 and provides a fluid outlet for pressurized brewed beverage that flows from within the brew tank 110. The outlet 215 is fluidly connected to the brew tank 110 via a beverage tube or spigot 216 (FIG. 4) connected to a riser tube 219 by an elbow 217 (FIG. 4).

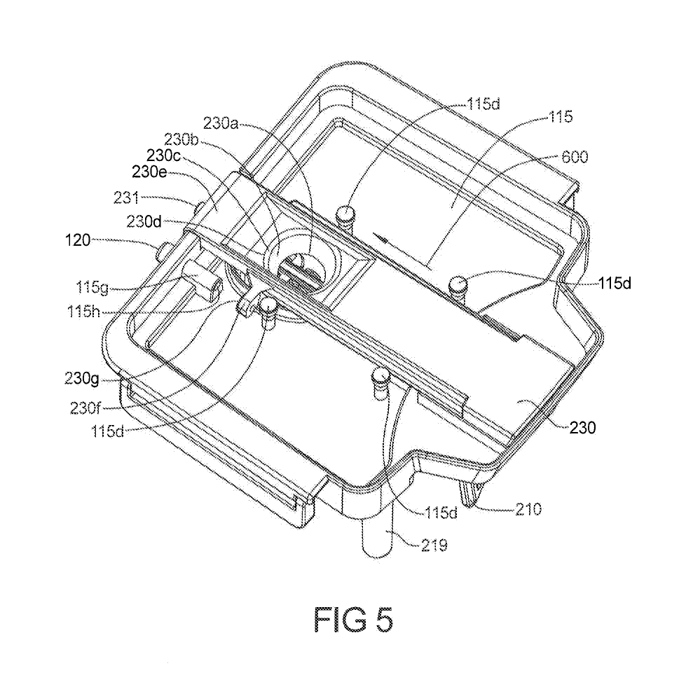

An air inlet coupling 120 (best seen in FIG. 5) extends rearwardly from the cover 115 for fluidly connecting to an air connection interface 405 disposed on a rear will 21 of the recess 20 when the brew tank assembly 100 is inserted into the recess 20. The air connection interface 405 is fluidly connected to an electric pump 150 (FIG. 7) which is energized when the actuator 210 is depressed. The air inlet coupling 120 is fluidly connected to the interior volume 110b (FIG. 4) of the brew tank 110 so that pressurized air from the electrical pump 150 (FIG. 7) pressurizes the interior volume 110b. An electrical interface/switch 406 (see also FIG. 7) is disposed on the rear wall 21 of the recess 20 for engaging the slider 230 when the brew tank assembly 100 is inserted into the recess 20 and the actuator 210 is depressed with the receptacle. When depressed by the slider 230, the switch 406 closes thereby energizing the electric pump 150 (FIG. 7). At the same time, the slider 230 causes a beverage mouth, seal 241 to seal a beverage mouth or inlet 115a in the lid 115. The pump 150 (FIG. 7) pumps pressurized air into the interior volume 110b (FIG. 4) of the brew tank 110 thereby positively pressurizing it and causing brewed beverage in the brew tank 110 to be forced through the riser tube 219, the beverage tube 216, and through the outlet 215 into the receptacle below.

In an embodiment, the operating pressure of the pump 150, the diameter of the riser tube 219, beverage tube 216 and outlet 215 are selected such that the flow rate of the beverage from the beverage tank 110 to the outlet 215 is optimized. For example, an optimal flow rate target for dispensing the beverage from the outlet 215 is in the range of 0.5 to 0.75 ounces per second. However, it should be understood that this is not meant to be limiting as there may be other embodiments of operating pressures, riser tube 219, beverage tube 216 and outlet 215 diameters that are possible to achieve other embodiments of a flow rate for dispensing the beverage from the outlet 215.

Referring now to FIG. 4, shown is an exploded view of an embodiment of a brew tank assembly 100. It should be understood that this embodiment of a brew tank assembly is not meant to be limiting as there could be other possible embodiments of the brew tank assembly 100. The brew tank assembly 100 is comprised of a brew tank 110, a lid 115, a lid seal 116 and a brew tank panel assembly 111. A lip 110a is formed in a periphery of an opening in one end of the brew tank 110 for receiving the lid seal 116 and the lid 115. The lid 115 is secured to the brew tank with a pair of handles 117 that are hingedly connected to opposing sides of the lid 115. The handles 117 engage a pair of complementary rails on opposing sides of the brew tank 110. The handles 117 are folded down for engaging the rails for securing the lid 115 to the brew tank 110. The handles 117 must be in the folded configuration in order for the brew tank 110 to be inserted into the recess 20 (FIG. 2).

In an embodiment, the brew tank 110 has a capacity of approximately 10-12 five ounce cups of a brewed beverage such as coffee. However, this is not meant to be limiting because in other embodiments the brew tank 110 may differ in the total capacity of the amount and number of cups of brewed beverage it holds.

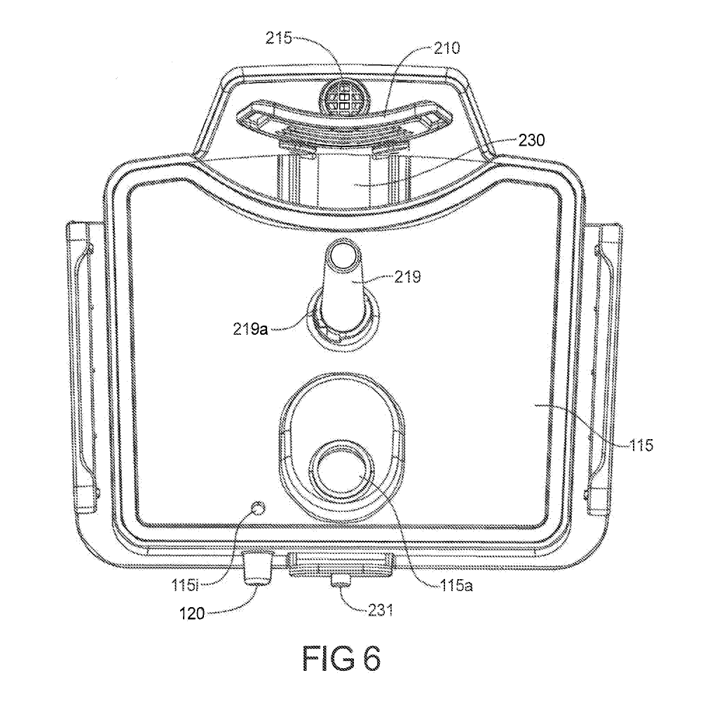

A riser tube 219 extends downwardly from the lid 115 into the interior volume 110b of the brew tank 110. A first end of the riser tube 219 is connected to the lid 115 with, for example, a bayonet type fitting 219a (FIG. 6) on a bottom side of the lid 115 for fluidly connecting the riser tube 219 to an aperture 115b formed in the lid 115. The second opposite end of the riser tube 219 is open and inserted into the brew tank 110. An elbow 217 on a first end of the beverage tube 216 is fitted into the aperture 115b fluidly connecting the riser tube 219 to the beverage tube 216. The second end of the beverage tube 216 may be fitted with an elbow 218 that is fitted through an aperture 115c in the lid 115. One end of the elbow 218 may be open forming the dispensing outlet 215 where the beverage is dispensed. A beverage tube cover 221 may be fitted over the beverage tube 221.

Still referring to FIG. 4 and now to FIG. 5, the lid 115 includes a beverage inlet or coffee mouth 115a where a beverage being brewed is gravity fed into the brew tank 110 from the brew head 300 (FIGS. 1 and 2) disposed above when the brew tank assembly 100 is inserted into the recess 21. A slide 230 is slidingly installed on a top side of the lid 115 by a pair of slide rails 232. The slide rails are attached to the lid 115 via a plurality of posts 115d and fasteners such as screws (not shown) and the like. The slide 230 is capable of movement between a first or normal position near the front of the lid 115 and a dispensing or second position disposed towards the rear of the lid 115. The actuator 210 is mounted on a first or front end of the slide 230. At least one spring 242 is used to bias the slide 230 in the first or normal position. The spring(s) 242 is positioned in a recess 115e formed in the lid 115 and engages a projection (not shown) on a bottom side of the slide 230. A beverage inlet valve 241 fits into the beverage inlet 115a and seals the beverage inlet 115a when the slide 230 is moved to the second position when the actuator 210 is depressed. A lever 240 is urged by slide 230 against the inlet valve 241 to urge the inlet valve 241 into the beverage inlet 115a when the slide 230 is moved into the second position as described more fully hereinbelow.

In an embodiment, a warmer plate 112 is positioned in a warmer plate recess 110c in an interior volume 110b of the brew tank 110 for transferring heat into the beverage in the brew tank 110. A seal 112a may be used to prevent the warmer plate 112 from overheating or burning the bottom of the brew tank 110 and for securing the warmer plate 112 in the warmer plate recess 110c. The warmer plate 112 transfers heat generated by the heating element 35 (FIG. 7) disposed in the base 15 (FIG. 2) when the brew tank assembly 100 is mounted in the recess 20 (FIG. 2) in the base 15 (FIG. 2).

Referring now to FIGS. 5 and 6, in the illustrated embodiment the lid 115 is provided with a vent 115h formed in an integrally molded boss 115g on an upper surface of the lid 115. The vent 1151i is fluidly connected to an orifice 115i on a lower surface of the lid 115. The vent 115h allows ambient air to enter and exit the interior volume 110a (FIG. 4) of the brew tank 110 when beverage is being brewed and dripped into the brew tank 110 through the beverage mouth 115a. Without the vent 115h open to ambient pressure, brewed beverage and in particular coffee tends to bubble in and seal the beverage mouth 115a due to the surface tension of the beverage. As a result, brewed beverage is prevented from entering into the tank 110 through beverage inlet 115a.

Oppositely, when the actuator 210 is depressed by the container and the slide 230 is moved in the direction of arrow 600, a plunger 230g disposed on a plunger arm 230f extending sidewardly from the slide 230 engages and seals vent 115h. Thus, the pump 150 (FIG. 7) when fluidly connected to the air connection interface 120 is also fluidly connected to the orifice 115i on the lower surface of the lid 115. This causes the brew tank 110 to be pressurized when the pump 150 (FIG. 7) is energized. As described above, the pump 150 (FIG. 7) is energized when the slide 230 is moved to the second position (in the direction of arrow 600) and the projection 231 engages the electrical interface/switch 406 (FIG. 2) disposed in the rear wall 21 (FIG. 2) of the recess 20 (FIG. 2).

Referring now to FIG. 7, shown is an exploded perspective view of the base 15. The base 15 is comprised of a housing 20, a bottom cover 22, a water tank assembly 25, and the lid 50. A funnel support 30 is inserted into a recess 25b in the water tank assembly 25. A funnel 40 fits into a recess 30a formed in the funnel support 30. In use, the funnel 40 receives a filter which may be a paper filter where an infusible material such as coffee grounds are received and heated water passed through for brewing a beverage. In another embodiment, the filter may be any other type of filtration media such as wire or plastic mesh, etc., having a suitable porosity and thickness for filtering a brewed beverage. The funnel 40 includes a funnel or filter basket beverage valve 42 disposed on the bottom that is normally biased in the closed position with a spring (not shown). The operation of the beverage valve 42 is described more fully hereinbelow.

Water is directed to the funnel 40 from a water reservoir 25a in the water tank assembly 25 through a water tube 27 that extends downwardly into the water reservoir 25a. A water level gauge 29 may be disposed in the water reservoir 25a of the water tank assembly 25 for determining how much water is in the water reservoir 25a upon filling or otherwise.

A sprayer 28 is fluidly connected to a first end of the water tube 27 and directs water into the funnel 40 and over the infusible material that is disposed in the filter in the funnel 40. In an embodiment, a replaceable water filter 39 may be inserted into the funnel 40 above the infusible material disposed in the filter and beneath the sprayer 28 for filtering the water from the water reservoir 25a for impurities. The sprayer 28 may be pivoting to enable the sprayer 28 to be pivoted out of the way to remove the filter basket 40 from the funnel support 30. The lid 50 may include a projection (not shown) that automatically moves the sprayer 28 back to the in-use position when the lid 50 is closed.

A second end of the water tube 27 is fitted into an opening (not shown) in the bottom of the water tank 25. A first end 60a of a u-shaped water heater 60 is inserted into the opening (not shown) and is thus fluidly connected to the second end of the water tube 27. A second end 60b of the u-shaped heater 60 is inserted into another opening (not shown) in the bottom of the water reservoir 25a of the water tank 25. Water from the water reservoir 25 flows by gravity into the u-shaped heater 60. When the u-shaped heater 60 is energized at the start of the brewing cycle, the water in the U-shaped heater 60 is heated and forced by the increased pressure through the water tube 27 to the sprayer 28. Sprayer 28 may have a plurality of downwardly directed holes (not shown) for evenly distributing heated water over the contents of the filter in the funnel 40. The heater 60 may include a check valve (not shown) for preventing the backflow of water into the water reservoir 25a when the water is heated forcing the heated water through the water tube 27. The operation of the heater 60 is known in the art and requires no further discussion.

The housing 20 includes a printed circuit hoard (PCB) 425 mounted thereon and protected by a printed circuit board cover 426 and seal 427. The PCB 425 includes the aforementioned electronic controls 400 (FIGS. 1 and 2) mounted thereon which protrude through a control panel 26 mounted on a front side of the water tank 25. A power board 450 mounted in a power box 457 in the housing 20 provides power to the PCB 425. Optionally, the base 15 may include a power cord box 70 where the power cord (not shown) supplying power to the electronic controls 400 (FIGS. 1 and 2) and power board 450 may be stored.

A heating element 35 may be mounted in a recess 20a formed in a bottom of housing 20 for keeping the brewed beverage at a desired temperature for a predetermined time. The operation of the heating element 35 may he controlled by the electronic controls 400 (FIGS. 1 and 2) and PCB 425. The heat generated by the heating element 35 when energized is transferred to a hot plate 36 disposed above the heater element 35. An insulating ring 37 may be used to prevent the heat from the heating element 35 transferred to the hot plate 35 from damaging the housing 20. A flange 38 may be used to secure the heating element 35, the hot plate 36 and the seal 37 to the housing 20. The hot plate 36 transfers the heat generated by the heater element 35 to the brew tank 110 via the warmer plate 112 positioned in the bottom of the brew tank 110 by conduction. Power is provided to the heating element 35 to generate heat from the power board 450 controlled by electronic controls 400 (FIGS. 1 and 2). Similarly, power is provided to the electrical pump 150 from the power board 450 for pressurizing the brew tank 110 when actuator 210 is engaged controlled by electronic controls 400 (FIGS. 1 and 2). The pump 150 is fluidly connected to the air connection interface 405 (see also FIG. 2).

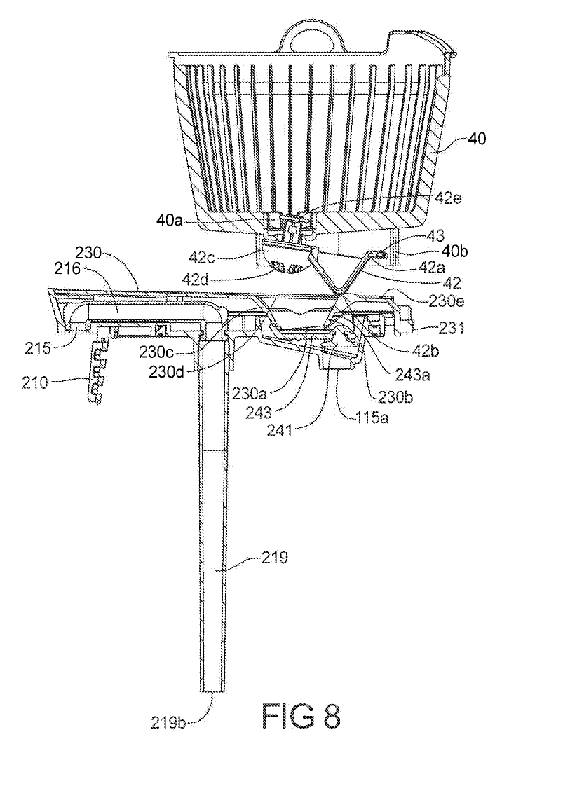

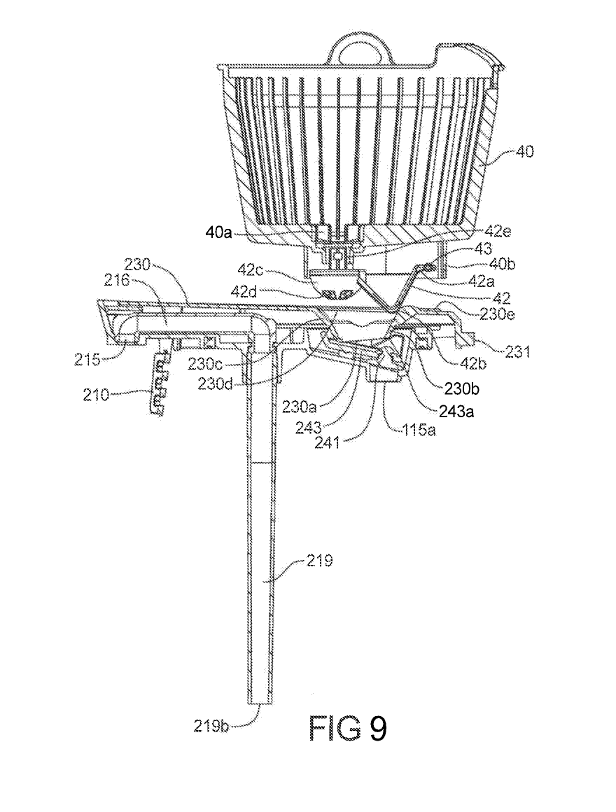

FIGS. 8 and 9 illustrate the operation of the actuator 210 and the slide 230 between the normal and the second or dispensing positions, according to an embodiment of the invention. It should be understood that this is not meant to be limiting as there could be other possible embodiments of an actuator and dispensing means for dispensing the brewed beverage. In particular, in FIG. 8 the slider 230 is in the first or normal position. When the brew tank assembly 100 is inserted into the recess 20 (FIG. 2), a planar surface 230e of the slide 230 urges against a sloped portion 42b of the beverage valve 42 causing the beverage valve 42 to pivot about a pin 43. The beverage valve 42 is normally biased downward by a spring (not shown) as described further below. The pin 43 pivotally connects a first end 42a of the beverage valve 42 to a bottom surface of the funnel 40. A second end of the beverage valve 42 has a mushroom-shaped head 42c formed thereon. The beverage valve 42 and pin assembly 43 are mounted in an enclosure 40b formed on the bottom of filter basket 40.

The mushroom-shaped head 42c has a plurality of openings 42d formed therein for allowing a beverage being brewed to pass therethrough from the brew basket 40 to the beverage inlet 230a in the slide 230 disposed beneath. The brew basket 40 has an opening 40a in the bottom for allowing the beverage being brewed to flow from the brew basket 40 to the mushroom-shaped head 42d. With the slide 230 in the normal position, a brew basket outlet valve 42c extending upwardly from the mushroom-shaped head 42c is in the open position allowing brewed beverage to pass through the openings 40a and 42d to the beverage inlet 230a. The slide 230 has a funnel-shaped portion 230b forming the beverage inlet 230a which serves to guide brewed beverage through the beverage inlet 230a. The beverage being brewed may then flow through the beverage mouth 115a in lid 115 past the brew tank inlet valve 241 and the lever 243 into the brew tank 110 (FIG. 4) disposed beneath.

In FIG. 9, the slide 230 is in the second or dispensing position as when the actuator 210 is depressed by the container. When the slide 230 is moved to the second position, pressure on the sloped portion 42b of the beverage valve 42 is released and the sloped portion 42b is free to move into a lip 230c of the funnel-shaped portion 230b of the slide 230. Since the beverage valve 42 is biased downward, the beverage valve 42 pivots downward causing the outlet valve 42e to seal the opening 40a in the bottom of the brew basket 40. Thus, a beverage being brewed is prevented from exiting the brew basket 40 when the actuator 210 is depressed by the container. At the same time, the funnel-shaped portion 230b urges against a ramped portion 243a of the lever 243 urging inlet valve 241 into the inlet opening 115a thereby sealing the brew tank 110 (FIG. 4) disposed beneath.

As described above, when the slide 230 is moved into the depressed or second position as shown in FIG. 9, the projection 231 on the slide 230 engages the switch 406 (FIG. 2) thereby energizing the pump 150 (FIG. 7). This causes air to be pumped through the air connection interface 405, the air inlet coupling 120 and the orifice 115i to the brew tank 100. The brew tank 110 is thereby pressurized and any beverage within the beverage tank 110 is forced through an open end 219b of the riser tube 219 into the riser tube 219 and to the outlet 215. Thus, brewed beverage is dispensed from the brewed beverage tank 110 to the container disposed beneath the outlet 215 until the actuator 210 is released. When the actuator 210 is released, the beverage valve 42 and the inlet valve 241 move hack to their normal positions and the flow of brewed beverage from the brew basket 40 to the brew tank 110 may resume. At the same time, projection 231 on the slide 230 releases the switch 402 and pump 150 is de-energized and the flow of brewed beverage through riser tube 219 and outlet 215 ceases.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A beverage maker and dispensing system (10), comprising:
a base (15);
a brewed beverage tank (110) removably mounted on the base (15) having an inlet (115a) and an outlet (215);
a brew head (300) for brewing a brewed beverage which is directed into the brewed beverage tank (110) through the inlet (115a);
an actuator (210) configured to dispense a brewed beverage from the outlet (215) when the actuator (210) is depressed; and
an electric pump (150) configured to pressurize the beverage tank (110) when the actuator (210) is depressed causing the brewed beverage to be dispensed.

2. The system (10) of claim 1, wherein said actuator (210) is depressed by urging a container against the actuator (210) for dispensing the brewed beverage into the container.

3. The system (10) of claim 1, further comprising:
an interface (405) for fluidly connecting the brewed beverage tank (110) to the electric pump (150) when the brewed beverage tank (110) is mounted on the base (15).

4. The system (10) of claim 1, further comprising:
a switch (406) disposed in the base (15) positioned to be engaged by the actuator (210) when the brewed beverage tank (110) is mounted on the base (15).

5. The system (10) of claim 4, wherein the switch (406) is engaged by the actuator (210) when the actuator (210) is depressed.

6. The system (10) of claim 5, wherein engaging the switch (406) energizes the electric pump (150) which is configured to pump an into the brewed beverage tank (110).

7. The system (10) of claim 6, wherein pumping air into the brewed beverage tank (110) pressurizes the brewed beverage tank (110) to force the brewed beverage from the brewed beverage tank (110) through the outlet (215).

8. The system (10) of claim 1, further comprising a lid (115) for sealing the brewed beverage tank (110).

9. The system (10) of claim 8, wherein the actuator (210) is slidingly positioned on the lid (115) and is moveable between a normal position and a dispensing position when depressed.

10. The system (10) of claim 1, further comprising:
a first valve (42) disposed beneath the brew head (300) configured to control the flow of the brewed beverage from the brew head (300) into the beverage inlet (115a), the first valve (42) being normally biased into an open position when the actuator (210) is in the normal position and in a closed position when the actuator (210) is depressed to prevent the brewed beverage from flowing into the brewed beverage tank (110) from the brew head (300) during brewing.

11. The system (10) claim 1, further comprising:
a second valve (241) disposed beneath the actuator (210) normally in an open position configured to allow the brewed beverage to flow from the brew head (300) to the beverage tank (110), and positioned to seal the inlet (115a) on the brewed beverage tank (110) when the actuator (210) is in the dispensing position, thereby allowing the electric pump (150) to pressurize the brewed beverage tank (110) when energized.

12. The system (10) of claim 4, wherein the actuator (210) includes a projection (231) that engages the switch (406) when the actuator (210) is depressed.

13. The system (10) of claim 8, further comprising a vent 115(h) in the lid (115) open to ambient pressure for venting the brewed beverage tank (110) when the actuator (210) is in the normal position.

14. The system (10) of claim 13, further comprising a third valve (230g) configured to seal said vent (115h) and normally biased into an open position when the actuator (210) is in the normal position, and that is moved to a closed position when said actuator (210) is depressed to seal said vent (115h).

15. The system (10) of claim 14, wherein said vent (115h) is formed in a boss (115g) in said lid (115), wherein one end of said boss (115g) is fluidly connected to said interface (405) and a second end is fluidly connected to an orifice (115i) in the bottom of said lid (115), and wherein when said third valve (230g) is open and said vent (115h) is not sealed, said interface (405) and said orifice (115i) do not form a fluid tight connection, and when said third valve (230g) is closed, said interface (405) and said orifice (115i) form a fluid tight connection and pressurized air from said electrical pump (150) when energized pressurizes said brewed beverage tank (110).

16. A beverage maker and dispensing system (10), comprising:
a base (15);
a pressurized brewed beverage tank (110) removably mounted on the base (15) having an inlet (115a) and an outlet (215);
a brew head (300) configured to brew a brewed beverage which is directed into the brewed beverage tank (110) through the inlet (115a); and
an actuator (210) configured to dispense a brewed beverage from the outlet (215) when the actuator (210) is depressed by a container.

17. The system (10) of claim 16, further comprising:
a second valve (42) disposed beneath the brew head (300) configured to control the flow of the brewed beverage from the brew head (300) into the inlet (115a) on the brewed beverage tank (110) during brewing, the second valve (42) being normally biased into an open position when the actuator (210) is in the normal position and in a closed position When the actuator (210) is depressed to prevent the brewed beverage from flowing into the brewed beverage tank (110) from the brew head (300).

18. The system (10) of claim 16, further comprising:
an interface (405) for fluidly connecting the brewed beverage tank (110) to the electric pump (150) when the brewed beverage tank (110) is mounted on the base (15).

19. The system (10) of claim 16, further comprising:
a switch (406) disposed in the base (15) positioned to be engaged by the actuator (210) when the brewed beverage tank (110) is mounted on the base (15).

20. The system (10) of claim 19, wherein the switch (406) is engaged by the actuator (210) when the actuator (210) is depressed, and when the switch (406) is engaged the pump (150) is energized which is configured to pump air into the brewed beverage tank (110) for pressurizing the brewed beverage tank (110).

21. The system 10 of claim 16, further comprising an electric pump (150) configured to pressurize the beverage tank (110) when the actuator (210) is depressed causing the brewed beverage to be dispensed.

22. The system 10 of claim 16, a first valve (241) disposed beneath the actuator (210) normally in an open position configured to allow the brewed beverage to flow from the brew head (300) to the beverage tank (110) during brewing, and positioned to seal the inlet (115a) on the brewed beverage tank (110) when the actuator (210) is in the dispensing position, thereby allowing the electric pump (150) to pressurize the brewed beverage tank (110) when energized.

23. The system (10) of claim 8, farther comprising a pair of handles (117) hingedly connected to opposing sides of the lid (115) and moved to a folded position to secure the lid (115) to the brewed beverage tank (110), wherein the handles (115) must be in the folded position in order for the brewed beverage tank (110) to be mounted in a recess (20) in the base (15).
